(19) United States
(12) Patent Application Publication
(10) Pub. No.: US 2023/0196648 A1
(43) Pub. Date: Jun. 22, 2023

(54) INFORMATION PROCESSING DEVICE, INFORMATION PROCESSING METHOD, AND STORAGE MEDIUM

(71) Applicant: TOYOTA JIDOSHA KABUSHIKI KAISHA, Toyota-shi Aichi-ken (JP)

(72) Inventors: Yuko Masuda, Okazaki-shi Aichi-ken (JP); Masato Endo, Nagoya-shi Aichi-ken (JP)

(73) Assignee: TOYOTA JIDOSHA KABUSHIKI KAISHA, Toyota-shi Aichi-ken (JP)

(21) Appl. No.: 17/968,209

(22) Filed: Oct. 18, 2022

(30) Foreign Application Priority Data
Dec. 22, 2021 (JP) 2021-208459

(51) Int. Cl. G06T 13/40; G07C 5/08

(52) U.S. Cl. CPC G06T 13/40; G07C 5/0825; G07C 5/0808

(57) ABSTRACT

An information processing device includes: an acquisition unit configured to acquire vehicle information of a vehicle; an evaluation unit configured to evaluate a driver's driving of the vehicle based on the vehicle information acquired by the acquisition unit; and a control unit configured to cause an avatar of the vehicle which is provided to the vehicle or the driver in correlation to grow or to change a degree of favorability of the avatar based on a result of evaluation from the evaluation unit.

### CROSS-REFERENCE TO RELATED APPLICATION

This application claims priority to Japanese Patent Application No. 2021-208459 filed on Dec. 22, 2021, incorporated herein by reference in its entirety.

### BACKGROUND

### 1. Technical Field

The disclosure relates to an information processing device, an information processing method, and a storage medium.

### 2. Description of Related Art

Japanese Unexamined Patent Application Publication No. 2021-43700 (JP 2021-43700 A) discloses a technique that can prompt a user to use a vehicle.

### SUMMARY

Recently, driving diagnosis which is evaluation of a driver's driving has been performed based on information on a vehicle which is driven by the driver. At this time, in order to promote the driver's safe driving, it is desirable to cause the driver to continuously use the driving diagnosis.

Here, a technique of promoting use of a vehicle is disclosed in JP 2021-43700 A, but a technique of causing a driver to continuously use driving diagnosis is not disclosed, and there is room for improvement in causing a driver to continuously use driving diagnosis.

The disclosure provides an information processing device, an information processing method, and a storage medium that can enhance a driver's desire to continuously use driving diagnosis.

In an aspect of the disclosure according to claim 1, there is provided an information processing device including: an acquisition unit configured to acquire vehicle information of a vehicle; an evaluation unit configured to evaluate a driver's driving of the vehicle based on the vehicle information acquired by the acquisition unit; and a control unit configured to cause an avatar of the vehicle which is provided to the vehicle or the driver in correlation to grow or to change a degree of favorability of the avatar based on a result of evaluation from the evaluation unit.

In the information processing device according to claim 1, the acquisition unit acquires vehicle information. The evaluation unit evaluates a driver's driving of the vehicle based on the vehicle information acquired by the acquisition unit. The control unit causes an avatar of the vehicle which is provided to the vehicle or the driver in correlation to grow or changes a degree of favorability of the avatar based on the result of evaluation from the evaluation unit. Accordingly, with the information processing device, it is possible to enhance the driver's desire to continuously use driving diagnosis by personifying the vehicle and causing the driver to feel fond of the avatar.

In the information processing device according to claim 2, in claim 1 a plurality of types of avatars may be provided as the avatar, and the information processing device may further include a first selection unit configured to select a first avatar correlated with the vehicle out of the plurality of types of avatars as an avatar which is to be displayed on a display unit.

In the information processing device according to claim 2, a plurality of types of avatars is provided as the avatar. The first selection unit selects the first avatar correlated with the vehicle out of the plurality of types of avatars as the avatar to be displayed on the display unit. Accordingly, with the information processing device, it is possible to enhance the driver's desire to continuously use driving diagnosis by continuously communing with one avatar while the driver occupies the vehicle.

In the information processing device according to claim 3, in claim 1, a plurality of types of avatars may be provided as the avatar, and the information processing device may further include a second selection unit configured to select a second avatar correlated with the driver out of the plurality of types of avatars as an avatar which is to be displayed on a display unit.

In the information processing device according to claim 3, a plurality of types of avatars is provided as the avatar. The second selection unit selects the second avatar correlated with the driver out of the plurality of types of avatars as the avatar to be displayed on the display unit. Accordingly, with the information processing device, it is possible to enhance the driver's desire to continuously use driving diagnosis by continuously communing with one avatar even when the driver uses different vehicles.

In any one of claims 1 to 3, the information processing device according to claim 4 may further include a first change unit configured to change a display mode of an avatar which is to be displayed on a display unit based on a type of the vehicle which is boarded by the driver.

In the information processing device according to claim 4, the first change unit changes the display mode of the avatar to be displayed on the display unit based on a type of the vehicle which is boarded by the driver. Accordingly, with the information processing device, it is possible to prompt the driver to use various vehicles in order to ascertain the avatar in different display modes.

In any one of claims 1 to 4, the information processing device according to claim 5 may further include a second change unit configured to change a display mode of an avatar which is to be displayed on a display unit based on the result of evaluation of the driver.

In the information processing device according to claim 5, the second change unit changes the display mode of the avatar to be displayed on the display unit based on the result of evaluation of the driver. For example, the second change unit may change the avatar in a display mode which varies depending on whether the result of evaluation of the driver is good or bad. Accordingly, with the information processing device, since the avatar is displayed in the display mode corresponding to the result of evaluation of the driver, it is possible to expect the driver's interest in driving diagnosis to increase.

In any one of claims 1 to 5, the information processing device according to claim 6 may further include a provision unit configured to provide an incentive for the avatar based on the result of evaluation of the driver.

In the information processing device according to claim 6, the provision unit provides an incentive for the avatar based on the result of evaluation of the driver. Accordingly, with the information processing device, it is possible to enhance the driver's desire to continuously use driving diagnosis in order to acquire the incentive.

In any one of claims 1 to 6, the information processing device according to claim 7 may further include an output unit configured to output a notification for the vehicle with an expression specific to the avatar.

In the information processing device according to claim 7, the output unit outputs a notification for the vehicle with an expression specific to the avatar. Accordingly, with the information processing device, since a notification for the vehicle is output with an expression specific to the avatar, it is possible to expect the driver's fondness for the vehicle to be enhanced.

There is provided an information processing method according to claim 8 which is performed by a computer, the information processing method including: acquiring vehicle information of a vehicle; evaluating a driver's driving of the vehicle based on the acquired vehicle information; and causing an avatar of the vehicle which is provided to the vehicle or the driver in correlation to grow or changing a degree of favorability of the avatar based on a result of evaluation.

There is provided a storage medium according to claim 9 storing an information processing program causing a computer to perform: acquiring vehicle information of a vehicle; evaluating a driver's driving of the vehicle based on the acquired vehicle information; and causing an avatar of the vehicle which is provided to the vehicle or the driver in correlation to grow or changing a degree of favorability of the avatar based on a result of evaluation.

As described above, with the information processing device, the information processing method, and the storage medium according to the aspects of the disclosure, it is possible to enhance a driver's desire to continuously use driving diagnosis.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration of an information processing system according to an embodiment;

FIG. 2 is a block diagram illustrating hardware configurations of an information processing device and a driver terminal according to the embodiment;

FIG. 3 is a block diagram illustrating a configuration of a storage unit of the information processing device according to the embodiment;

FIG. 4 is a block diagram illustrating an example of a functional configuration of the information processing device according to the embodiment;

FIG. 5 is a diagram illustrating an example of a plurality of avatars according to the embodiment;

FIG. 6 is a block diagram illustrating a hardware configuration of a vehicle according to the embodiment;

FIG. 7 is a first flowchart illustrating a flow of a selection process which is performed by the information processing device according to the embodiment;

FIG. 8 is a flowchart illustrating a flow of a display process which is performed by the information processing device according to the embodiment;

FIG. 9 is a diagram illustrating a first display example which is displayed on a monitor of the vehicle according to the embodiment;

FIG. 10 is a diagram illustrating a second display example which is displayed on the monitor of the vehicle according to the embodiment;

FIG. 11 is a diagram illustrating a third display example which is displayed on the monitor of the vehicle according to the embodiment;

FIG. 12 is a diagram illustrating a fourth display example which is displayed on the monitor of the vehicle according to the embodiment;

FIG. 13 is a second flowchart illustrating a flow of the selection process which is performed by the information processing device according to the embodiment;

FIG. 14 is a diagram illustrating a fifth display example which is displayed on the monitor of the vehicle according to the embodiment; and

FIG. 15 is a diagram illustrating a sixth display example which is displayed on the monitor of the vehicle according to the embodiment.

### DETAILED DESCRIPTION OF EMBODIMENTS

Hereinafter, an information processing system 10 according to an embodiment of the disclosure will be described. The information processing system 10 according to an embodiment is a system that for enhancing a driver's desire to continuously use an evaluation function regarding driving of a vehicle (hereinafter referred to as “driving diagnosis”).

### First Embodiment

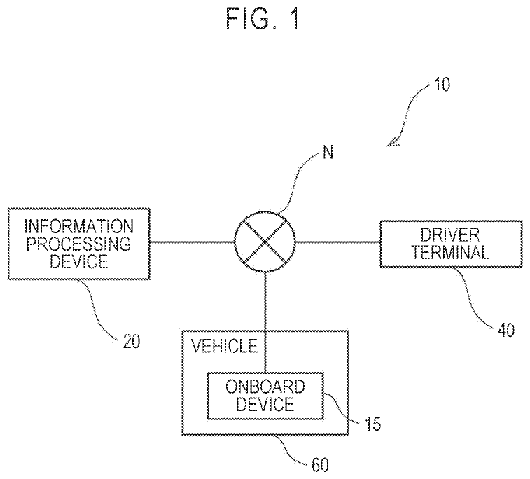

An information processing system 10 according to a first embodiment will be described first below. FIG. 1 is a diagram schematically illustrating a configuration of the information processing system 10.

As illustrated in FIG. 1, the information processing system 10 includes an information processing device 20, a driver terminal 40, and a vehicle 60. The information processing device 20, the driver terminal 40, and an onboard device 15 which is mounted in the vehicle 60 are connected via a network N and are configured to communicate with each other.

The information processing device 20 is a server computer which is owned by a predetermined service provider. The information processing device 20 comprehensively manages vehicle information of the vehicle 60 and avatar information of an avatar. In the first embodiment, the information processing device 20 manages avatars in correlation with vehicles 60. The information processing device 20 transmits avatar information including an image and a voice of an avatar to the driver terminal 40 and the vehicle 60 on the basis of vehicle information acquired from the vehicles 60, and provides the avatar information to a driver of the vehicle 60.

The driver terminal 40 is a mobile terminal which is carried by the driver of the vehicle 60. For example, a personal computer (a notebook PC), a smartphone, or a tablet terminal which is portable is used as the driver terminal 40. In the first embodiment, for example, the driver terminal 40 is a smartphone. The driver terminal 40 transmits operation details of the driver to the information processing device 20 via a network N.

The vehicle 60 may be one of an engine vehicle, a hybrid electric vehicle, and a battery electric vehicle, but for example, the vehicle 60 is an engine vehicle in the first embodiment. As described above, the vehicle 60 transmits vehicle information to the information processing device 20 via the network N.

Here, an application (hereinafter referred to as a “driving diagnosis application”) for providing a result of driving diagnosis for a driver of the vehicle 60 (hereinafter referred to as a “driving diagnosis result”) is installed in the driver terminal 40 and the vehicle 60. The driving diagnosis application provides a driving diagnosis result, communicates with the information processing device 20 via the network N, and displays an image included in avatar information acquired from the information processing device 20 or outputs sound included in the avatar information.

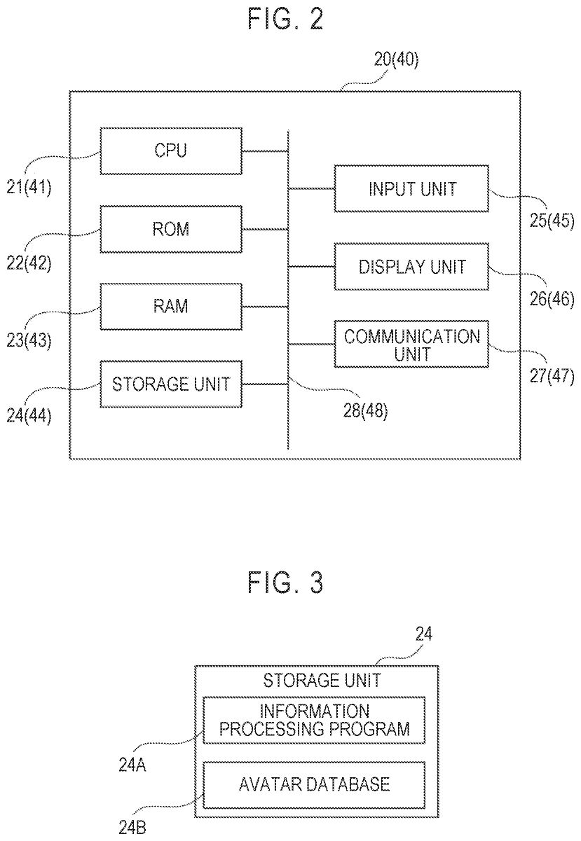

Hardware configurations of the information processing device 20 and the driver terminal 40 will be described below. FIG. 2 is a block diagram illustrating the hardware configurations of the information processing device 20 and the driver terminal 40. Since the information processing device 20 and the driver terminal 40 basically have a general computer configuration, the information processing device 20 will be representatively described below.

As illustrated in FIG. 2, the information processing device 20 includes a central processing unit (CPU) 21, a read only memory (ROM) 22, a random access memory (RAM) 23, a storage unit 24, an input unit 25, a display unit 26, and a communication unit 27. These elements are communicatively connected to each other via a bus 28.

The CPU 21 is a central processing unit and executes various programs or controls the constituents thereof. That is, the CPU 21 reads a program from the ROM 22 or the storage unit 24 and executes the program using the RAM 23 as a work area. The CPU 21 performs control of the constituents and various arithmetic processes in accordance with a program stored in the ROM 22 or the storage unit 24.

The ROM 22 stores various programs and various types of data. The RAM 23 serves as a work area and temporarily stores programs or data.

The storage unit 24 is constituted by a storage device such as a hard disk drive (HDD), a solid state drive (SSD), a flash memory, or the like and stores various programs and various types of data.

The input unit 25 includes a point device such as a mouse, a keyboard, a microphone, and a camera and is used to input various types of information.

The display unit 26 is, for example, a liquid crystal display and displays various types of information. The display unit 26 may employ a touch panel system and serve as the input unit 25.

The communication unit 27 is an interface for communicating with other devices. This communication employs, for example, a wired communication standard such as Ethernet (registered trademark) or FDDI or a wireless communication standard such as 4G, 5G, Bluetooth (registered trademark), or Wi-Fi (registered trademark).

FIG. 3 is a block diagram illustrating a configuration of the storage unit 24 of the information processing device 20. As illustrated in FIG. 3, an information processing program 24A for performing at least a selection process and a display process which will be described later is stored in the storage unit 24. When the information processing program 24A is executed, the information processing device 20 performs processes based on the information processing program 24A using the hardware resources illustrated in FIG. 2.

The storage unit 24 includes an avatar database (hereinafter referred to as an “avatar DB”) 24B that manages avatar information. The avatar DB 24B manages a vehicle ID specific to a corresponding vehicle 60, image information, sound information, status information, and favorability information in correlation with an avatar ID (identification) specific to an avatar as avatar information. The image information is information on an image of an avatar. The sound information is information on sound of an avatar. The status information includes, for example, an age of an avatar, image information and sound information of an avatar for each age, and a total evaluation value (which will be described later) required for growth to the next age. The favorability information is information indicating a degree of favorability of a driver for an avatar.

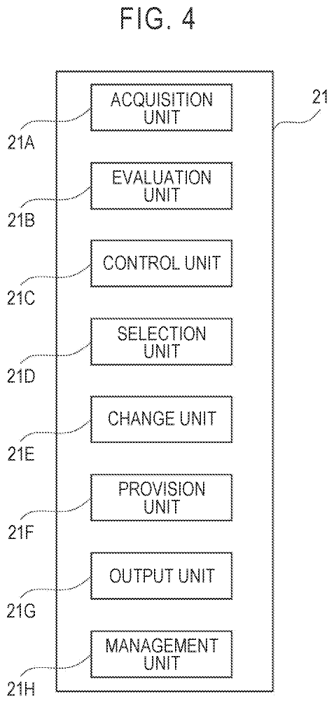

the functional configuration of the information processing device 20 will be described below. FIG. 4 is a block diagram illustrating an example of the functional configuration of the CPU 21 of the information processing device 20.

As illustrated in FIG. 4, the CPU 21 of the information processing device 20 includes an acquisition unit 21A, an evaluation unit 21B, a control unit 21C, a selection unit 21D, a change unit 21E, a provision unit 21F, an output unit 21G, and a management unit 21H as functional elements. Theses functional configurations are realized by causing the CPU 21 to read and execute the information processing program 24A stored in the storage unit 24.

The acquisition unit 21A acquires vehicle information of the vehicle 60. For example, the acquisition unit 21A acquires a steering angle, an acceleration, a vehicle speed, and a direction indicator operation of the vehicle 60 detected by a steering angle sensor 71, an acceleration sensor 72, a vehicle speed sensor 73, and a direction indicator switch 74 (which will be described below) of the vehicle 60 as the vehicle information. The acquisition unit 21A acquires an engine rotation speed, an engine torque, fuel efficiency, and an accelerator operation of the vehicle 60 detected by an ECU 70C (which will be described later) of the vehicle 60 as the vehicle information. The acquisition unit 21A acquires a vehicle ID of the vehicle 60 which is boarded by a driver as the vehicle information. This information is a part of the vehicle information which can be acquired from the vehicle 60 by the acquisition unit 21A, and the acquisition unit 21A also acquires information of the vehicle 60 other than this information from the vehicle 60 as the vehicle information.

The evaluation unit 21B performs driving diagnosis of a driver of the vehicle 60 based on the vehicle information acquired by the acquisition unit 21A. For example, the evaluation unit 21B performs driving diagnosis based on whether a plurality of evaluation items is good or bad.

The plurality of evaluation items includes, for example, acceleration, steering, braking, and echo. In the first embodiment, the evaluation unit 21B calculates an individual evaluation value of each of the plurality of evaluation items based on the vehicle information and calculates a total evaluation value by totaling the calculated individual evaluation values of the items. For example, the evaluation unit 21B calculates the individual evaluation value of an evaluation item “braking” from a braking operation such as sudden braking and temporary stop based on the vehicle information. The evaluation unit 21B calculates the individual evaluation value of each of the plurality of evaluation items, the total evaluation value, and a point value as a driving diagnosis result based on the total evaluation value.

The control unit 21C causes an avatar of the vehicle 60 which is provided in correlation with the vehicle 60 to grow or changes a degree of favorability of the avatar based on the driving diagnosis result from the evaluation unit 21B. When the avatar of the vehicle 60 is caused to grow or the degree of favorability of the avatar is changed, the control unit 21C updates avatar information of the avatar in the avatar DB 24B. In the first embodiment, for example, growth of an avatar is set to increase the age of the avatar.

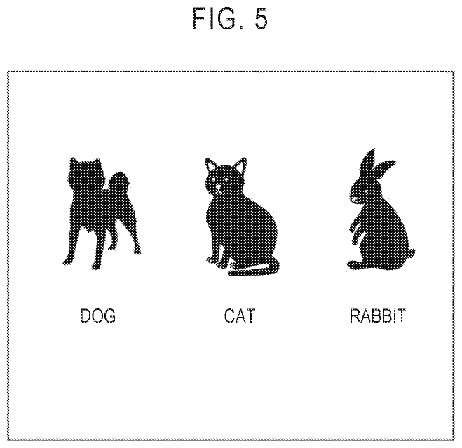

In the first embodiment, a plurality of types of avatars is provided. FIG. 5 is a diagram illustrating examples of the plurality of avatars. As illustrated in FIG. 5, in the first embodiment, three types of avatars including a “dog,” a “cat,” and a “rabbit” are provided as the plurality of avatars. In the first embodiment, when a vehicle 60 is purchased, one of the three types is provided as an avatar correlated with the vehicle 60. For example, in the first embodiment, it is assumed that a dog is provided as an avatar correlated with the vehicle 60.

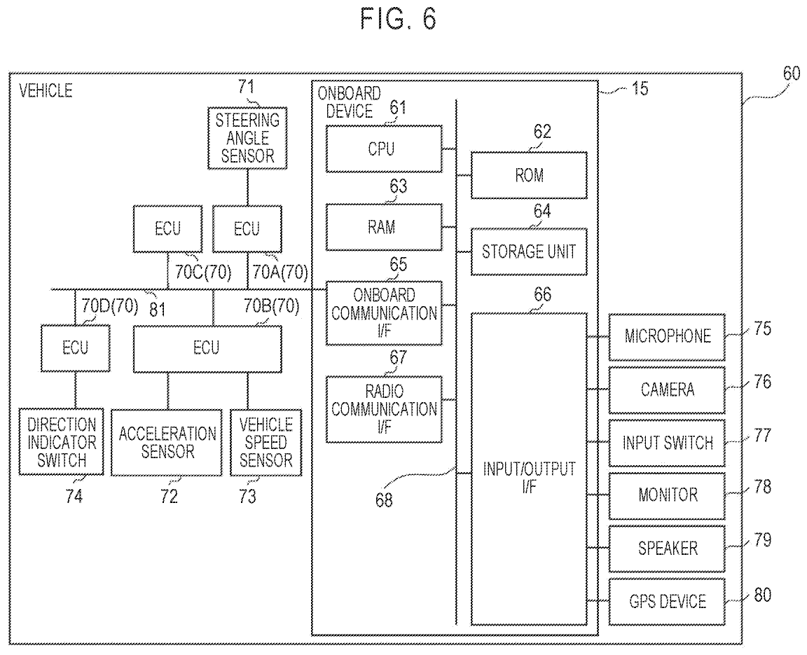

Referring back to FIG. 4, the selection unit 21D selects a dog correlated with the vehicle 60 out of the plurality of avatars as an avatar to be displayed on a display unit 46 of the driver terminal 40 and a monitor 78 (see FIG. 6 which will be described later). For example, the selection unit 21D identifies an avatar ID corrected with a vehicle ID of the vehicle 60 boarded by a driver in the avatar DB 24B based on the vehicle ID and selects the avatar indicated by the identified avatar ID as an avatar of the vehicle 60. Accordingly, in the first embodiment, when there is a plurality of drivers of a vehicle 60 and one driver drives the vehicle 60, the avatar of a dog corrected with the vehicle 60 is displayed on the monitor 78. Accordingly, according to the first embodiment, by causing the plurality of drivers to face the common avatar correlated with the vehicle 60, it is possible to expect each of the plurality of drivers to keep in mind safe driving for the avatar. The selection unit 21D is an example of a “first selection unit,” the dog is an example of a “first avatar,” and the display unit 46 and the monitor 78 are an example of a “display unit.”

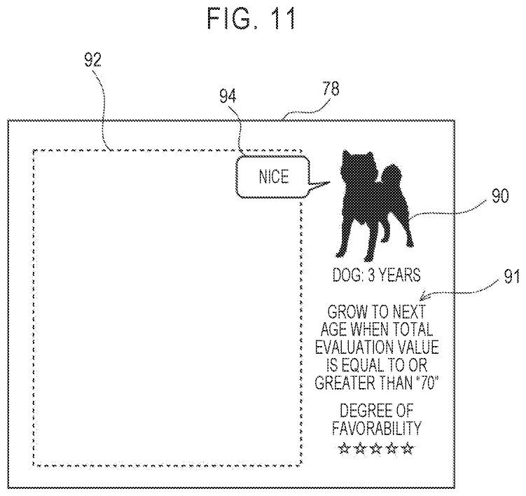

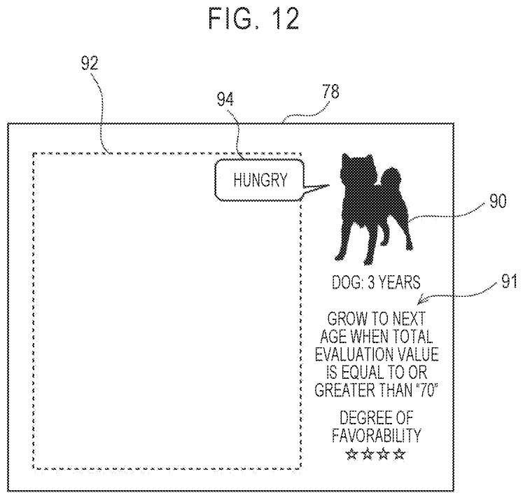

The change unit 21E changes a display mode of the avatar which is displayed on the display unit 46 and the monitor 78 according to the driving diagnosis result of the driver. For example, the change unit 21E changes the avatar in a display mode corresponding to whether the individual evaluation value of each evaluation item is good or bad. Although details will be described later, the avatar is changed into a display mode in which the avatar delivers a message using a speech balloon 94 (see FIGS. 11 and 12) which will be described later in the first embodiment. The change unit 21E is an example of a “second change unit.”

The provision unit 21F provides an incentive for an avatar based on the driving diagnosis result of a driver. The incentive is at least one of an empirical value, an item, a costume, and a skill which can be used by avatars. In the first embodiment, for example, it is assumed that the incentive is a costume which can be used by avatars.

Here, when a point value acquired based on the driving diagnosis result from the evaluation unit 21B reaches a predetermined threshold value, the provision unit 21F provides an incentive for the avatar. In the first embodiment, for example, the threshold value is provided in a plurality of stages including “50,” “70,” and “100.” The provision unit 21F provides an incentive corresponding to the reached threshold value whenever the total of the acquired point values reaches the threshold value in each stage.

The output unit 21G outputs a notification associated with the vehicle 60 with an expression specific to an avatar. For example, in the first embodiment, an expression specific to an avatar is referred to as a “way of speaking specific to the avatar.” The output unit 21G causes the display unit 46 and the monitor 78 to display a notification associated with the vehicle 60 with a speech ending varying by avatars and outputs a speaker (not illustrated) of the driver terminal 40 and the speaker 79 of the vehicle 60. The notification associated with the vehicle 60 is not particularly limited in details as long as it can notify a driver of the information associated with the vehicle 60 and may be, for example, an advice corresponding to the driving diagnosis result.

The management unit 21H generates avatar information on the avatar selected by the selection unit 21D and transmits the generated avatar information to the driver terminal 40 and the vehicle 60.

The hardware configuration of the vehicle 60 will be described below. FIG. 6 is a block diagram illustrating the hardware configuration of the vehicle 60.

As illustrated in FIG. 6, the vehicle 60 includes an onboard device 15, a plurality of electronic control units (ECUs) 70, a steering angle sensor 71, an acceleration sensor 72, a vehicle speed sensor 73, a direction indicator switch 74, a microphone 75, a camera 76, an input switch 77, a monitor 78, a speaker 79, and a GPS device 80.

The onboard device 15 includes a CPU 61, a ROM 62, a RAM 63, a storage unit 64, an onboard communication interface (I/F) 65, an input/output I/F 66, and a radio communication I/F 67. The CPU 61, the ROM 62, the RAM 63, the storage unit 64, the onboard communication I/F 65, the input/output I/F 66, and the radio communication I/F 67 are communicatively connected to each other via an internal bus 68.

The CPU 61 is a central processing unit that executes various programs or controls the constituent elements. That is, the CPU 61 reads a program from the ROM 62 or the storage unit 64 and executes the program using the RAM 63 as a work area. The CPU 61 performs control of the constituent elements and various processes in accordance with a program stored in the ROM 62 or the storage unit 64.

The ROM 62 stores various programs and various types of data. The RAM 63 serves as a work area and temporarily stores a program or data.

The storage unit 64 is constituted by a storage device such as an HDD, an SSD, or a flash memory and stores various programs and various types of data. In the first embodiment, a vehicle ID which is vehicle information is stored in the storage unit 64.

The onboard communication I/F 65 is an interface for connection to the ECU 70. The interface employs a communication standard based on a CAN protocol. The onboard communication I/F 65 is connected to an external bus 81.

The ECU 70 is provided for each function of the vehicle 60, and an ECU 70A, an ECU 70B, an ECU 70C, and an ECU 70D are provided in the first embodiment. The ECU 70A is, for example, an ECU for electric power steering, and the steering angle sensor 71 is connected to the ECU 70A. The ECU 70B is, for example, an ECU for vehicle stability control (VSC), and the acceleration sensor 72 and the vehicle speed sensor 73 are connected to the ECU 70B. In addition to the acceleration sensor 72 and the vehicle speed sensor 73, a yaw rate sensor may be connected to the ECU 70B.

The ECU 70C is, for example, an engine ECU and detects an engine rotation speed and an engine torque of the vehicle 60 to control an engine. The ECU 70C detects fuel efficiency based on a fuel flow rate acquired from sensors which are not illustrated. The ECU 70C detects an accelerator operation of the vehicle 60. The engine rotation speed, the engine torque, the fuel efficiency, and the accelerator operation detected by the ECU 70C are stored in the storage unit 64 and are transmitted as vehicle information to the information processing device 20. The ECU 70D is, for example, a steering ECU, and a direction indicator switch 74 is connected to the ECU 70D. The direction indicator switch 74 is provided in a steering column for operating a direction indicator. The ECU 70D detects a driver's operation of the direction indicator switch 74 as the direction indicator operation. The direction indicator detected by the ECU 70D is stored in the storage unit 64 and is transmitted as vehicle information to the information processing device 20.

The steering angle sensor 71 is a sensor that detects a steering angle of a steering wheel. The steering angle detected by the steering angle sensor 71 is stored in the storage unit 64 and is transmitted as vehicle information to the information processing device 20.

The acceleration sensor 72 is a sensor that detects an acceleration acting on the vehicle 60. The acceleration sensor 72 is, for example, a three-axis acceleration sensor and detects accelerations in a vehicle length direction which is an X-axis direction, a vehicle width direction which is a Y-axis direction, and a vehicle height direction which is a Z-axis direction. The accelerations detected by the acceleration sensor 72 are stored in the storage unit 64 and are transmitted as vehicle information to the information processing device 20.

The vehicle speed sensor 73 is a sensor that detects a vehicle speed of the vehicle 60. The vehicle speed sensor 73 is, for example, a sensor that is provided in wheels. The vehicle speed detected by the vehicle speed sensor 73 is stored in the storage unit 64 and is transmitted as vehicle information to the information processing device 20.

The input/output I/F 66 is an interface that communicates with the microphone 75, the camera 76, the input switch 77, the monitor 78, the speaker 79, and the GPS device 80 which are mounted in the vehicle 60.

The microphone 75 is provided in a front pillar or a dashboard of the vehicle 60 and is a device that collects a voice uttered by a driver of the vehicle 60. The microphone 75 may be provided in the camera 76 which will be described later.

The camera 76 includes, for example, a charge coupled device (CCD) image sensor. The camera 76 is provided, for example, in an upper part of a front windshield or a dashboard in the vehicle 60 and faces the driver. The camera 76 images an area including a driver's face. The image of the driver's face captured by the camera 76 is stored in the storage unit 64 and is transmitted to the information processing device 20. The camera 76 may be connected to the onboard device 15 via the ECU 70 (for example, a camera ECU).

The input switch 77 is a switch that is provided in an instrument panel, a center console, a steering wheel, or the like and is used to input an operation which is performed with a driver's finger. For example, a numeric keyboard of a push button type and a touch pad can be employed as the input switch 77.

The monitor 78 is provided in an instrument panel, a meter panel, or the like and is a liquid crystal monitor that displays proposal of operations associated with the functions of the vehicle 60 and an image associated with description of the functions. The monitor 78 may be provided as a touch panel also serving as the input switch 77. For example, an image included in avatar information acquired from the information processing device 20 is displayed on the monitor 78.

The speaker 79 is provided in an instrument panel, a center console, a front pillar, a dashboard, or the like and is a device that outputs proposal of operations associated with the functions of the vehicle 60 and sound associated with description of the functions. The speaker 79 may be provided in the monitor 78. For example, sound included in avatar information acquired from the information processing device 20 is output from the speaker 79.

The GPS device 80 is a device that measures a current position of the vehicle 60. The GPS device 80 includes an antenna (not illustrated) that receives signals from GPS satellites. The GPS device 80 may be connected to the onboard device 15 via a car navigation system connected to the ECU 70 (for example, a multimedia ECU).

The radio communication I/F 67 is a radio communication module that communicates with the information processing device 20. The radio communication module employs, for example, a communication standard such as 5G, LTE, or Wi-Fi (registered trademark). The radio communication I/F 67 is connected to the network N.

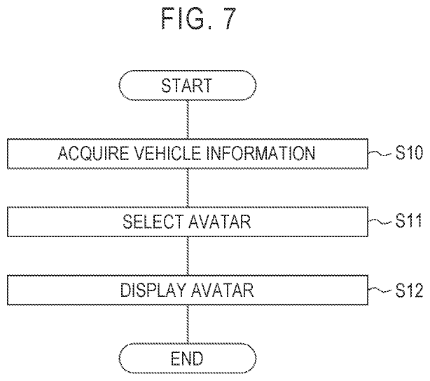

FIG. 7 is a first flowchart illustrating a flow of a selection process of selecting an avatar to be displayed on the display unit 46 and the monitor 78 which is performed by the information processing device 20. The selection process is performed by causing the CPU 21 to read the information processing program 24A from the storage unit 24, to load the information processing program 24A to the RAM 23, and execute the information processing program 24A.

In Step S10 illustrated in FIG. 7, the CPU 21 acquires vehicle information from the vehicle 60. Then, the process flow proceeds to Step S11. In the first embodiment, for example, vehicle information is periodically transmitted from the vehicle 60 to the information processing device 20.

In Step S11, the CPU 21 selects an avatar indicated by an avatar ID correlated with a vehicle ID included in the vehicle information acquired in Step S10 out of a plurality of avatars based on the vehicle ID. Then, the process flow proceeds to Step S12.

In Step S12, the CPU 21 transmits avatar information on the avatar selected in Step S11 to the driver terminal 40 and the vehicle 60 and causes the display unit 46 and the monitor 78 to display an image of the avatar included in the avatar information. Then, the selection process ends.

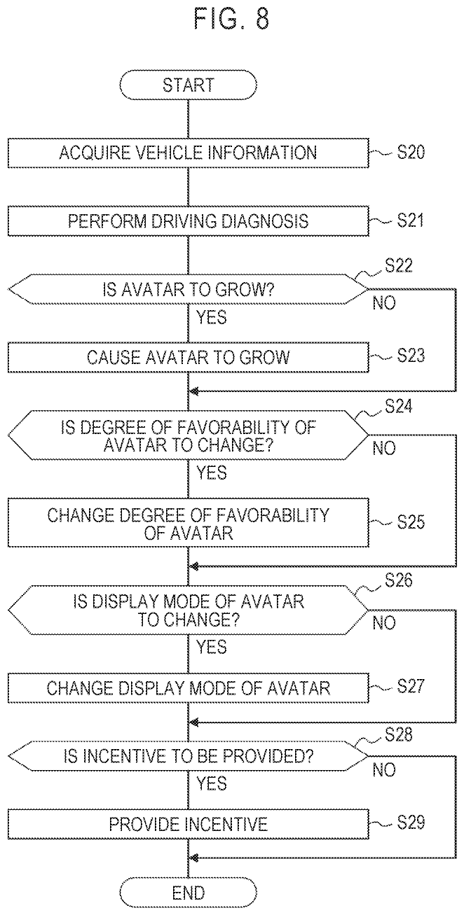

FIG. 8 is a flowchart illustrating a flow of a display process associated with display details after an avatar has been displayed on the display unit 46 and the monitor 78 by the information processing device 20. The display process is performed by causing the CPU 21 to read the information processing program 24A from the storage unit 24, to load the information processing program 24A to the RAM 23, and execute the information processing program 24A.

In Step S20 illustrated in FIG. 8, the CPU 21 acquires vehicle information from the vehicle 60. Then, the process flow proceeds to Step S21.

In Step S21, the CPU 21 performs driving diagnosis of a driver of the vehicle 60 based on the vehicle information acquired in Step S20. For example, the CPU 21 calculates an individual evaluation value of each item of a plurality of evaluation items of the driver, a total evaluation value, and a point value as the driving diagnosis result based on the vehicle information. At this time, the CPU 21 sets 1/10 of the total evaluation value as a point value. The point value is rounded off below the decimal point. Then, the process flow proceeds to Step S22.

In Step S22, the CPU 21 determines whether the avatar is made to grow based on the driving diagnosis result and causes the process flow to proceed to Step S23 when it is determined that the avatar is made to grow (Step S22: YES). On the other hand, when the CPU 21 determines that the avatar is not made to grow (Step S22: NO), the process flow proceeds to Step S24. In the first embodiment, for example, the CPU 21 determines that the avatar is made to grow when the total evaluation value of the driver is equal to or greater than a predetermined value.

In Step S23, the CPU 21 causes the avatar to grow. Then, the process flow proceeds to Step S24.

In Step S24, the CPU 21 determines whether a degree of favorability of the avatar is to be changed based on the driving diagnosis result, and the process flow proceeds to Step S25 when it is determined that the degree of favorability of the avatar is to be changed (Step S24: YES). On the other hand, when the CPU 21 determines that the degree of favorability of the avatar is not to be changed (Step S24: NO), the process flow proceeds to Step S26. In the first embodiment, for example, when the total evaluation value of the driver is equal to or less than a predetermined value or is equal to or less than a specific value less than the predetermined value, the CPU 21 determines that the degree of favorability of the avatar is to be changed.

In Step S25, the CPU 21 changes the degree of favorability of the avatar. Then, the process flow proceeds to Step S26. In the first embodiment, for example, the CPU 21 increases the degree of favorability of the avatar when the total evaluation value of the driver is equal to or greater than the predetermined value and decreases the degree of favorability of the avatar when the total evaluation value is equal to or less than the specific value.

In Step S26, the CPU 21 determines whether a display mode of the avatar is to be changed based on the driving diagnosis result, and the process flow proceeds to Step S27 when it is determined that the display mode of the avatar is to be changed (Step S26: YES). On the other hand, when the CPU 21 determines that the display mode of the avatar is not to be changed (Step S26: NO), the process flow proceeds to Step S28. In the first embodiment, for example, when the individual evaluation value of an evaluation item of the driver is equal to or greater than a predetermined value or is equal to or less than a specific value, the CPU 21 determines that the display mode of the avatar is to be changed.

In Step S27, the CPU 21 changes the display mode of the avatar. Then, the process flow proceeds to Step S28. In the first embodiment, for example, the CPU 21 displays a display mode in which the avatar is happy with an expression corresponding to the evaluation item when the individual evaluation value of the evaluation item of the driver is equal to or greater than the predetermined value and displays a display mode in which the avatar is sad with an expression corresponding to the evaluation item when the individual evaluation value is equal to or less than the specific value.

In Step S28, the CPU 21 determines whether an incentive for the avatar is to be provided based on the driving diagnosis result, and the process flow proceeds to Step S29 when it is determined that an incentive is to be provided (Step S28: YES). On the other hand, when the CPU 21 determines that an incentive is not to be provided (Step S28: NO), the display process ends. In the first embodiment, for example, when the total of the acquired point values reaches the threshold value in each stage, the CPU 21 determines that an incentive is to be provided.

In Step S29, the CPU 21 provides an incentive for the avatar. Then, the display process ends.

A display example based on the selection process illustrated in FIG. 7 or the display process illustrated in FIG. 8 will be described below. In the following description, a display example on the monitor 78 of the vehicle 60 will be described.

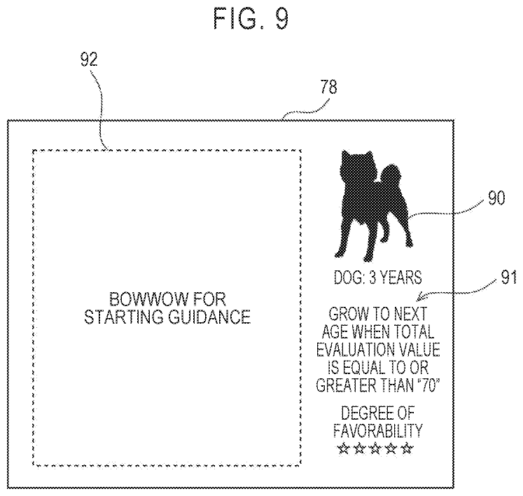

FIG. 9 is a first display example which is displayed on the monitor 78 of the vehicle 60. The CPU 21 of the information processing device 20 displays the display example illustrated in FIG. 9 on the monitor 78 when the engine of the vehicle 60 is started and a destination is set.

In the display example illustrated in FIG. 9, an avatar image 90, message information 91, and a notification area 92 are displayed.

The avatar image 90 is an image indicating an avatar imitating a person, an animal, a plant, or an imaginary creature. In FIG. 9, an image of an avatar of a dog is displayed as the avatar image 90.

The message information 91 indicates various messages for a driver. For example, in FIG. 9, “dog: 3 years, grow to next age at total evaluation value of “70” or greater, degree of favorability *****” is displayed as the message information 91. In this way, the message information 91 illustrated in FIG. 9 shows that the age of the avatar is 3 years and the total evaluation value of “70” or more in the driving diagnosis result needs to be acquired for growth to 4 years. The message information 91 illustrated in FIG. 9 shows that the degree of favorability of the avatar is “5 stars.” For example, in the first embodiment, the degree of favorability of the avatar increases as the number of stars increases.

The notification area 92 is an area in which a notification for the vehicle 60 is displayed. For example, in FIG. 9, “bowwow for starting guidance” is displayed as a notification indicating that the car navigation system is performed in a frame of the notification area 92. In this way, in the first embodiment, a speech ending “bowwow” which is a way of speaking specific to the avatar of a dog is added to the notification and displayed on the monitor 78. In the first embodiment, when “bowwow for starting guidance” is displayed in the frame of the notification area 92, a voice “bowwow for starting guidance” is output as a voice of the avatar from the speaker 79.

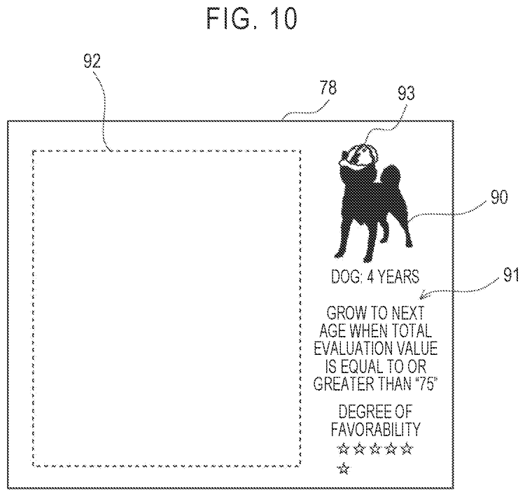

FIG. 10 is a second display example which is displayed on the monitor 78 of the vehicle 60. The display example illustrated in FIG. 10 shows a state in which driving diagnosis of the driver of the vehicle 60 has been performed after the display example illustrated in FIG. 9 has been displayed on the monitor 78.

In the display example illustrated in FIG. 10, an avatar image 90, message information 91, and a notification area 92 are displayed.

Unlike FIG. 9, an avatar of a dog wearing a cap 93 is displayed in the avatar image 90 illustrated in FIG. 10. The cap 93 is an incentive which has been provided based on the driving diagnosis result of the driver of the vehicle 60.

In FIG. 10, “dog: 4 years, grow to next age at total evaluation value of “75” or greater, degree of favorability ******” is displayed as the message information 91. In this way, the message information 91 illustrated in FIG. 10 shows that the age of the avatar grows to 4 years with respect to the display example illustrated in FIG. 9 and the degree of favorability of the avatar increases to “6 stars.” The message information 91 illustrated in FIG. 10 shows that the total evaluation value of “75” or more in the driving diagnosis result needs to be acquired for growth to 5 years.

In the notification area 92 illustrated in FIG. 10, since there is no notification to be displayed for the vehicle 60, the frame is blank.

FIG. 11 is a third display example which is displayed on the monitor 78 of the vehicle 60. The display example illustrated in FIG. 11 shows a state in which driving diagnosis of the driver of the vehicle 60 has been performed after the display example illustrated in FIG. 9 has been displayed on the monitor 78.

In the display example illustrated in FIG. 11, an avatar image 90, message information 91, a notification area 92, and a speech balloon 94 are displayed. The message information 91 illustrated in FIG. 11 is the same as in FIG. 9, the notification area 92 illustrated in FIG. 11 is the same as in FIG. 10, and thus description thereof will be omitted.

Unlike FIG. 9, an avatar of a dog with the speech balloon 94 added thereto is displayed in the avatar image 90 illustrated in FIG. 11. The speech balloon 94 is displayed based on the driving diagnosis result of the driver of the vehicle 60. Details displayed in the speech balloon 94 vary depending on whether the individual evaluation value for each evaluation item in the driving diagnosis result is good or bad. For example, in FIG. 11, since the individual evaluation value for an evaluation item “steering” is equal to or greater than a predetermined value, a message “nice” is displayed as an expression of happiness of the avatar corresponding to the evaluation item “steering” in the speech balloon 94.

FIG. 12 is a fourth display example which is displayed on the monitor 78 of the vehicle 60. The display example illustrated in FIG. 12 shows a state in which driving diagnosis of the driver of the vehicle 60 has been performed after the display example illustrated in FIG. 9 has been displayed on the monitor 78.

In the display example illustrated in FIG. 12, an avatar image 90, message information 91, a notification area 92, and a speech balloon 94 are displayed. The notification area 92 illustrated in FIG. 12 is the same as in FIG. 10 and thus description thereof will be omitted.

Similarly to FIG. 11, an avatar of a dog with the speech balloon 94 added thereto is displayed in the avatar image 90 illustrated in FIG. 12. In the display example illustrated in FIG. 12, for example, since the individual evaluation value of an evaluation item “eco” is equal to or less than a specific value, a message “hungry” is displayed as an expression of sadness of the avatar corresponding to the evaluation item “eco” in the speech balloon 94.

In FIG. 12, “dog: 3 years, grow to next age at total evaluation value of “70” or greater, degree of favorability ****” is displayed as the message information 91. In this way, the message information 91 illustrated in FIG. 12 shows that the degree of favorability of the avatar decreases to “4 stars” from the display example illustrated in FIG. 9.

As described above, the CPU 21 of the information processing device 20 acquires vehicle information. The CPU 21 performs driving diagnosis of a driver of the vehicle 60 based on the acquired vehicle information. The CPU 21 causes an avatar of the vehicle 60 which is provided to the vehicle 60 in correlation to grow or changes the degree of favorability of the avatar based on the driving diagnosis result of the driver of the vehicle 60. Accordingly, with the information processing device 20, it is possible to enhance the driver's desire to continuously use the driving diagnosis by personifying the vehicle 60 and causing the driver to feel fond of the avatar.

In the information processing device 20, a plurality of types of avatars is provided as the avatar. The CPU 21 selects a dog correlated with the vehicle 60 out of the plurality of types of avatars as the avatar to be displayed on the display unit 46 of the driver terminal 40 and the monitor 78 of the vehicle 60. Accordingly, with the information processing device 20, it is possible to enhance the driver's desire to continuously use the driving diagnosis by continuously communing with one avatar while the driver occupies the vehicle 60.

In the information processing device 20, the CPU 21 changes the display mode of the avatar to be displayed on the display unit 46 and the monitor 78 based on the driving diagnosis result of the driver of the vehicle 60. For example, the CPU 21 may change the avatar in the display mode which varies depending on whether the individual evaluation value for each evaluation item is good or bad. Accordingly, with the information processing device 20, since the avatar is displayed in the display mode corresponding to the driving diagnosis result of the driver, it is possible to expect the driver's interest in the driving diagnosis to increase.

In the information processing device 20, the CPU 21 provides an incentive for the avatar based on the driving diagnosis result of the driver of the vehicle 60. Accordingly, with the information processing device 20, it is possible to enhance the driver's desire to continuously use the driving diagnosis in order to acquire the incentive.

In the information processing device 20, the CPU 21 outputs a notification for the vehicle 60 with an expression specific to the avatar. Accordingly, with the information processing device 20, since a notification for the vehicle 60 is output with an expression specific to the avatar, it is possible to expect the driver's fondness for the vehicle 60 to be enhanced.

### Second Embodiment

A second embodiment will be described below while omitting or simplifying the same description as in the first embodiment.

In the second embodiment, unlike the first embodiment, the information processing device 20 manages avatars for drivers of a vehicle 60 in correlation. Specifically, in the second embodiment, in the avatar DB 24B of the storage unit 24, driver information of the drivers of the vehicle 60, image information, sound information, status information, and favorability information are managed in correlation with avatar IDs which are avatar information. Identification information for uniquely identifying the drivers of the vehicle 60 which is the driver information is stored in the storage unit 24. In the second embodiment, for example, identification information included in the driver information is referred to as a “face image of a driver.”

In the second embodiment, vehicle model information indicating the type of the vehicle 60 is stored as the vehicle information in the storage unit 64 of the vehicle 60.

The functional configuration of the information processing device 20 according to the second embodiment will be described below. The CPU 21 of the information processing device 20 has the functional configuration illustrated in FIG. 4 similarly to the first embodiment, but both embodiments are different in the functions of the acquisition unit 21A, the control unit 21C, the selection unit 21D, and the change unit 21E.

The acquisition unit 21A in the second embodiment acquires vehicle model information of the vehicle 60 boarded by a driver as the vehicle information in addition to the vehicle information acquired in the first embodiment. The acquisition unit 21A acquires driver information in addition to the vehicle information.

The control unit 21C in the second embodiment causes an avatar of the vehicle 60 which is provided to the driver of the vehicle 60 in correlation to grow or changes the degree of favorability of the avatar based on the driving diagnosis result from the evaluation unit 21B.

The selection unit 21D in the second embodiment identifies, for example, an avatar ID correlated with the driver information in the avatar DB 24B based on the driver information of the driver of the vehicle 60 and selects an avatar indicated by the identified avatar ID as the avatar of the vehicle 60. Accordingly, in the second embodiment, even when a driver boards another vehicle 60, a common avatar correlated with the driver is displayed on the display unit 46 of the driver terminal 40 and the monitor 78 of the vehicle 60. The selection unit 21D is an example of a “second selection unit.”

The change unit 21E in the second embodiment changes the display mode of the avatar to be displayed on the display unit 46 and the monitor 78 based on the type of the vehicle 60 boarded by the driver. For example, in the second embodiment, the type of the vehicle 60 is a vehicle model. For example, the change unit 21E displays a black-painted avatar on the display unit 46 and the monitor 78 when the driver is in a vehicle of vehicle model A, and displays a white-painted avatar on the display unit 46 and the monitor 78 when the driver is in a vehicle of vehicle model B. The change unit 21E is an example of a “first change unit.”

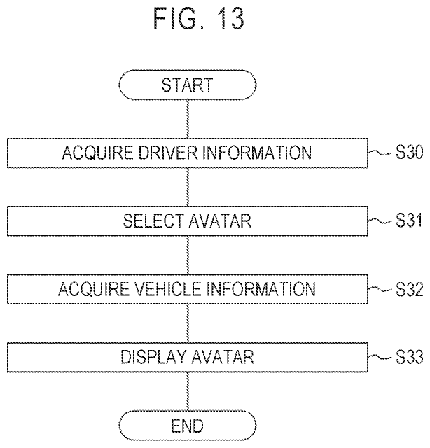

A flow of a selection process of selecting an avatar of a vehicle 60 provided to a driver of the vehicle 60 in correlation therewith will be described below with reference to FIG. 13. FIG. 13 is a second flowchart illustrating a process flow of the selection process which is performed by the information processing device 20.

In Step S30 illustrated in FIG. 13, the CPU 21 acquires driver information from the vehicle 60. Then, the process flow proceeds to Step S31. In the second embodiment, a face image of the driver captured by the camera 76 when the driver boards the vehicle 60 is transmitted as the driver information to the information processing device 20.

In Step S31, the CPU 21 selects an avatar indicating an avatar ID correlated with the driver information out of a plurality of avatars based on the driver information acquired in Step S30. Then, the process flow proceeds to Step S32.

In Step S32, the CPU 21 acquires vehicle information from the vehicle 60. Then, the process flow proceeds to Step S33.

In Step S33, the CPU 21 transmits avatar information of the avatar selected in Step S31 to the driver terminal 40 and the vehicle 60 and causes the display unit 46 and the monitor 78 to display the avatar image included in the avatar information in the display mode based on the vehicle model information included in the vehicle information acquired in Step S32. Then, the selection process ends.

A display example based on the display process illustrated in FIG. 13 will be described below. In the following description, a display example on the monitor 78 of the vehicle 60 will be described as an example.

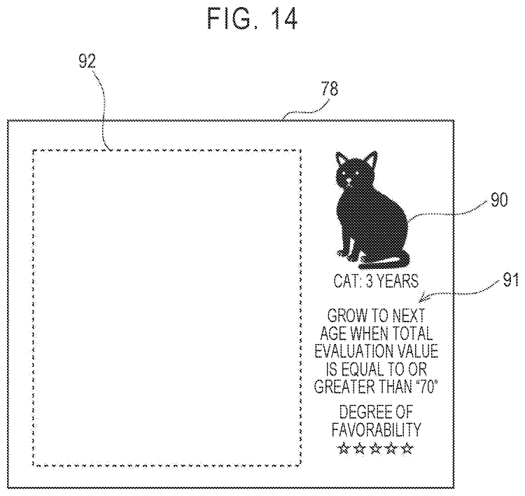

FIG. 14 is a fifth display example which is displayed on the monitor 78 of the vehicle 60. The CPU 21 of the information processing device 20 displays the display example illustrated in FIG. 14 on the monitor 78 when a driver X boards the vehicle 60 of the vehicle model A and the engine of the vehicle 60 is started.

In the display example illustrated in FIG. 14, an avatar image 90, a message information 91, and a notification area 92 are displayed.

Unlike the first embodiment, an image of an avatar of a cat is displayed in the avatar image 90 illustrated in FIG. 14. In the second embodiment, at the time of purchasing the vehicle 60, one of “dog,” “cat,” and “rabbit” is provided as an avatar correlated with a driver of the vehicle 60. For example, in the second embodiment, it is assumed that a cat is provided as an avatar correlated with the driver X. The cat is an example of a “second avatar.”

In FIG. 14, “cat: 3 years, grow to next age at total evaluation value of “70” or greater, degree of favorability *****” is displayed as the message information 91.

In the notification area 92 illustrated in FIG. 14, since there is no notification to be displayed for the vehicle 60, the frame is blank.

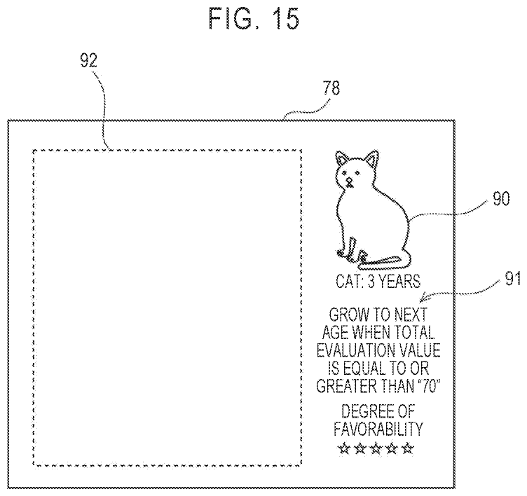

FIG. 15 is a sixth display example which is displayed on the monitor 78 of the vehicle 60. The CPU 21 of the information processing device 20 displays the display example illustrated in FIG. 15 on the monitor 78 when a driver X boards the vehicle 60 of the vehicle model B and the engine of the vehicle 60 is started.

In the display example illustrated in FIG. 15, an avatar image 90, message information 91, and a notification area 92 are displayed. The message information 91 and the notification area 92 illustrated in FIG. 15 are the same as in FIG. 14 and thus description thereof will be omitted.

The avatar image 90 illustrated in FIG. 15 is an image of an avatar of the same cat as in FIG. 14 and is different from that illustrated in FIG. 14 in color of the avatar. Specifically, the avatar image 90 illustrated in FIG. 14 is a “black cat” which is painted in black, and the avatar image 90 illustrated in FIG. 15 is a “white cat” which is painted in white.

As described above, in the information processing device 20, the CPU 21 selects the cat correlated with the driver X out of a plurality of avatars as the avatar to be displayed on the display unit 46 of the driver terminal 40 and the monitor 78 of the vehicle 60. Accordingly, with the information processing device 20, it is possible to enhance the driver's desire to continuously use the driving diagnosis by continuously communing with one avatar even when the driver uses different vehicles 60.

In the information processing device 20, the CPU 21 changes the display mode of the avatar to be displayed on the display unit 46 and the monitor 78 based on the type of the vehicle 60 which is boarded by the driver. Accordingly, with the information processing device 20, it is possible to prompt the driver to use various vehicles 60 in order to ascertain the avatar in different display modes.

Others

In the aforementioned embodiments, the avatar is displayed on the driver terminal 40 and the vehicle 60, but the disclosure is not limited thereto and the avatar may be displayed on one of the driver terminal 40 and the vehicle 60. Instead of or in addition to the driver terminal 40 and the vehicle 60, the avatar may be displayed on a game terminal and a television or a PC connected to the game terminal.

In the aforementioned embodiments, growth of an avatar is defined as increasing the age of the avatar. However, the disclosure is not limited thereto, but growth of an avatar may be defined as changing the appearance of the avatar, changing the size of the avatar, or the like.

In the aforementioned embodiments, one avatar which is provided in correlation with a vehicle 60 or a driver of the vehicle 60 out of a plurality of types of avatars may be selected by the driver or randomly.

In the aforementioned embodiments, changing of the display mode of an avatar based on a driving diagnosis result of a driver is defined as causing the avatar to notify of a message using a speech balloon 94. However, the disclosure is not limited thereto, but changing the display mode of an avatar may be defined as causing the avatar to perform an operation corresponding to whether an individual evaluation value of each evaluation item is good or bad.

In the aforementioned embodiments, an incentive is provided when a point value obtained based on the driving diagnosis result reaches a predetermined threshold value. However, the disclosure is not limited thereto, but the incentive may be provided when the total evaluation value of a driver is equal to or greater than a predetermined value, when the number of times of driving of the vehicle 60 is greater than a predetermined number, or the like.

In the aforementioned embodiments, a notification for a vehicle 60 is displayed on the display unit 46 and the monitor 78 with an expression specific to an avatar and is output from the speaker of the driver terminal 40 and the speaker 79 of the vehicle 60 with an expression specific to the avatar. However, the disclosure is not limited thereto, but the notification may be performed using the display unit 46 and the monitor 78 or using the speaker of the driver terminal 40 and the speaker 79 of the vehicle 60.

In the aforementioned embodiments, a type of a vehicle 60 is defined as a vehicle model, but the disclosure is not limited thereto. The type of a vehicle 60 may be defined as a type of a vehicle manufacturer that manufactures the vehicle 60, a type of a color, or the like. Changing the display mode of an avatar based on the type of the vehicle 60 is not limited to changing the color of the avatar, but may be defined as changing a costume of the avatar, changing a logo which is added to the costume, or the like.

In the aforementioned embodiments, the avatar image 90 which is displayed on the display unit 46 and the monitor 78 may be an image in which portions such as eyes and a nose are displayed in a face area of an avatar and a look of the avatar can be recognized by a driver based on change in position of the portions in the face area. The avatar image 90 may be a three-dimensional image in which a motion, a posture, and the like of an avatar can be recognized by a driver.

In the aforementioned embodiments, the selection process and the display process which are performed by causing the CPU 21 to read software (a program) may be performed by various processors other than the CPU. Examples of the processor in this case include a programmable logic device (PLD) of which a circuit configuration can be changed after being manufactured such as a field-programmable gate array (FPGA) and a dedicated electric circuit which is a processor having a circuit configuration designed dedicatedly for performing a specific process such as an application-specific integrated circuit (ASIC). The selection process and the display process may be performed by one of such various processors or may be performed by a combination of two or more processors of the same type or different types (for example, a combination of a plurality of FPGAs or a combination of a CPU and an FPGA). The hardware structure of such various processors is more specifically an electric circuit in which circuit elements such as semiconductor elements are combined.

In the aforementioned embodiments, the information processing program 24A is stored (installed) in the storage unit 24 in advance, but the disclosure is not limited thereto. The information processing program 24A may be provided in a state in which the information processing program is stored in a storage medium such as a compact disk read only memory (CD-ROM), a digital versatile disk read only memory (DVD-ROM), or a universal serial bus (USB) memory. The information processing program 24A may be downloaded from an external device via the network N.

What is claimed is:

1. An information processing device comprising:
an acquisition unit configured to acquire vehicle information of a vehicle;
an evaluation unit configured to evaluate a driver's driving of the vehicle based on the vehicle information acquired by the acquisition unit; and
a control unit configured to cause an avatar of the vehicle which is provided to the vehicle or the driver in correlation to grow or to change a degree of favorability of the avatar based on a result of evaluation from the evaluation unit.

2. The information processing device according to claim 1, wherein a plurality of types of avatars is provided as the avatar, and
wherein the information processing device further comprises a first selection unit configured to select a first avatar correlated with the vehicle out of the plurality of types of avatars as an avatar which is to be displayed on a display unit.

3. The information processing device according to claim 1, wherein a plurality of types of avatars is provided as the avatar, and
wherein the information processing device further comprises a second selection unit configured to select a second avatar correlated with the driver out of the plurality of types of avatars as an avatar which is to be displayed on a display unit.

4. The information processing device according to claim 1, further comprising a first change unit configured to change a display mode of an avatar which is to be displayed on a display unit based on a type of the vehicle which is boarded by the driver.

5. The information processing device according to claim 1, further comprising a second change unit configured to change a display mode of an avatar which is to be displayed on a display unit based on the result of evaluation of the driver.

6. The information processing device according to claim 1, further comprising a provision unit configured to provide an incentive for the avatar based on the result of evaluation of the driver.

7. The information processing device according to claim 1, further comprising an output unit configured to output a notification for the vehicle with an expression specific to the avatar.

8. An information processing method which is performed by a computer, the information processing method comprising:
acquiring vehicle information of a vehicle;
evaluating a driver's driving of the vehicle based on the acquired vehicle information; and
causing an avatar of the vehicle which is provided to the vehicle or the driver in correlation to grow or changing a degree of favorability of the avatar based on a result of evaluation.

9. A non-transitory storage medium storing an information processing program causing a computer to perform:
acquiring vehicle information of a vehicle;
evaluating a driver's driving of the vehicle based on the acquired vehicle information; and
causing an avatar of the vehicle which is provided to the vehicle or the driver in correlation to grow or changing a degree of favorability of the avatar based on a result of evaluation.
